(19) United States
(12) Patent Application Publication
(10) Pub. No.: US 2005/0236737 A1
(43) Pub. Date: Oct. 27, 2005

(54) Method for locating a decorative piece in a mold and the mold

(75) Inventor: Wei-Hong Lu, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: FIH CO., LTD, Shindian City (TW)

(21) Appl. No.: 11/106,179

(22) Filed: Apr. 12, 2005

(30) Foreign Application Priority Data
Apr. 24, 2004 (CN) 200410027083.X

(51) Int. Cl. B29C 45/00

(52) U.S. Cl. 264/275; 425/406; 249/140

(57) ABSTRACT

A mold such as an injection mold (10, 20) for locating a decorative sheet (30) therein and manufacturing a molded product using the decorative sheet includes a female mold (12) defining a molding recess (122), and a male mold (14) having a core insert (142). The molding recess is partly bounded by a marginal area (146). The core insert includes a main portion (144) and a locating portion (146). When the locating portion is received in the molding recess, the locating portion slidably engages with the marginal area of the molding recess and abuts against the decorative sheet. A method for locating the decorative sheet in a molding cavity of the injection mold is also provided.

### FIELD OF THE INVENTION

The present invention relates to methods for locating decorative pieces in molds and molds used for this purpose, and particularly to a method for locating a decorative pieces in a mold and a mold used for this purpose.

### BACKGROUND OF THE INVENTION

The decoration of a variety of molded products is often attained by applying decorating indicia to the product during the molding process. This is known as the technique of in-mold decorating. Usually, the technique is practiced by pre-feeding decorative material into a mold in which the product is to be formed. The decorative material is attached on the surface of the molded product after a mold cavity containing the decorative material is injection molded. Thus, the decorative material needs to be accurately placed into position so that the decoration thereof is aligned with the intended location on the product. Then the product is molded in contact with the decorative material. After cooling, the product with the decorative material is removed out from the mold, thereby completing the fabrication of the product.

FIG. 4 shows an injection mold 40 as a typical example in the art. The injection mold 40 includes a female mold 42 and a male mold 44. A preformed decorative material 50 is placed into a molding recess (not labeled) in the female mold 42 until it abuts an inner surface 43 of the female mold 42. When the injection mold 40 is closed, a molding cavity 46 in the shape of a product to be molded is defined between the decorative material 50 and the male mold 44. A peripheral interface area 48 perpendicular to a mold closing direction Z is defined between the female mold 42 and the male mold 44. Plastic material is injected into the molding cavity 46, and the plastic material and the decorative material 50 together form the molded product. A height of the molding recess is the same as a height of the decorative material 50 in the female mold 42.

The above-mentioned in-mold decorating technique has a number of drawbacks, which are particularly significant in high speed, continuous molding manufacturing. When the decorative material 50 is placed into the molding recess of the female mold 42, it may not tightly contact the inner surface 43. If so, it is likely that the decorative material 50 will be out of position; for example, with one side of the decorative material 50 protruding out above the molding recess. Further, the decorative material 50 may be unsteady and be easily displaced before the mold 40 is closed. When this happens, the decorative material 50 may not properly attach to the surface of the molded product. Further, even if the decorative material 50 is properly attached to said surface, it is liable to be misaligned and not at the intended location on the product. Moreover, the molded product is apt to have defects such as burring. Thus, the quality and aesthetic appearance of the molded product is reduced.

Accordingly, in general, a special tool such as a locating mechanism is needed to correctly position the decorative material 50. However, this takes extra time and is liable to increase costs.

What is needed, therefore, is a method for locating a decorative sheet in a mold and a mold used for such method.

### SUMMARY

A method for locating a decorative sheet in a mold is provided, in which the method is time-saving and inexpensive. In a preferred embodiment, the method comprises the steps of: providing a mold, the mold comprising a female mold defining a molding recess and a male mold having a core insert, the molding recess having a marginal area, the core insert includes a main portion and a locating portion; placing the decorative piece in the molding recess of the female mold and pushing the decorative piece into the molding recess; closing the female mold and the male mold together, with the main portion being received in the molding recess, and the locating portion slidably engaging with the marginal area and pushing the decorative piece to a correct location.

A mold is provided used for locating a decorative sheet therein and manufacturing a molded product using the decorative piece comprises includes a female mold defining a molding recess, and a male mold having a core insert. The molding recess is partly bounded by a marginal area. The core insert includes a main portion and a locating portion. When the locating portion is received in the molding recess, the locating portion slidably engages with the marginal area of the molding recess and abuts against the decorative piece.

It is of advantage that the locating portion abuts against the decorative piece into a proper position. Thus, the decorative piece would be indexed into position so that the decoration would be aligned with the intended location on the products, after which the product would be molded against the decorative piece.

Other objects, advantages and novel features of the preferred and other embodiments will become more apparent from the following detailed description when taken in conjunction with the accompanying drawings, in which:

### BRIEF DESCRIPTION OF THE DRAWINGS

FIG. 1 is a cross-sectional view of a mold according to a first embodiment of the present invention, showing the mold opened and with a decorative sheet located therewithin;

FIG. 2 is similar to FIG. 1, but showing the mold closed;

FIG. 3 is a cross-sectional view of a mold according a second embodiment of the present invention, showing the mold closed and with a decorative sheet located therewithin; and

FIG. 4 is a cross-sectional view of a conventional molding apparatus for in-mold decorating, showing the mold closed and with a decorative sheet located therewithin.

### DETAILED DESCRIPTION OF PERFERRED EMBODIMENTS

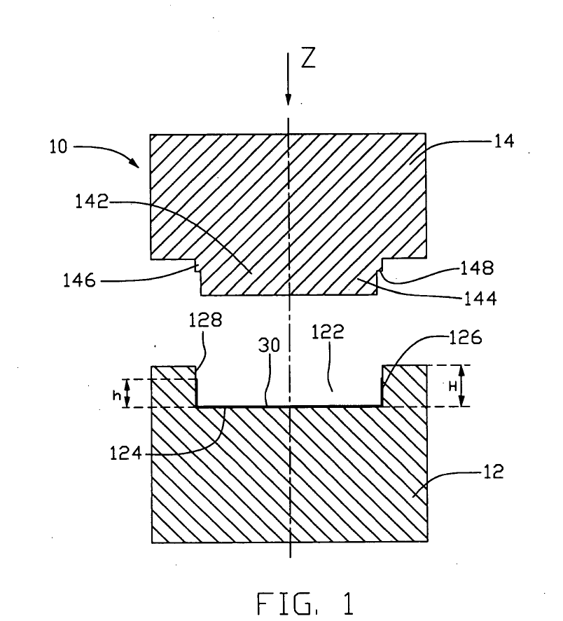

FIG. 1 shows a mold 10 with a decorative sheet 30 according to a first embodiment of the present invention. The mold 10 is used to locate the decorative sheet 30 and mold a molded product so that the decorative sheet 30 is attached on the molded product. The mold 10 may be an injection mold, which comprises a female mold 12 and a male mold 14. With the mold 10 opened, the male mold 14 is positioned away from the female mold 12. The decorative sheet 30 occupies a three-dimensional space, and is positioned in the female mold 12 as shown in FIG. 1.

The decorative sheet 30 has an outer surface (not labeled) and an inner surface (not labeled). When the decorative sheet 30 is introduced into the mold 10, the outer surface of the decorative sheet 30 abuts against an inner surface of the female mold 12, so that the decorative sheet 30 can be integrated with the molded product to form a decorative layer on a surface of the molded product. Desirably, the decorative sheet 30 is preformed by a vacuum forming method or a vacuum-pressure forming method, prior to injection molding using the mold 10. By such means, the decorative sheet 30 is formed so as to conform to the inner surface of the female mold 12. In one kind of preforming method, a precursor decorative sheet is preformed in a preforming mold, and then the precursor decorative sheet is placed in a female mold of an injection mold and duly molded to yield the prepared decorative sheet 30. In another kind of preparing method, the decorative sheet 30 is directly molded in a female mold of an injection mold. Usually, the latter kind of preforming method is used. Further, preforming of the decorative sheet 30 may be omitted altogether. In such case, a decorative sheet 30 may be formed so as to conform to the shape of the inner surface of the female mold 12. This is practicable if the height of the molded product is not very great, the curvatures of curved portions of the molded product are relatively small, and/or the decorative sheet 30 has sufficiently high moldability (thermoplasticity).

The female mold 12 defines a molding recess 122 in an upper portion thereof. The molding recess 12 is surrounded by a bottom surface 124 and a peripheral side surface 126 perpendicular to the bottom surface 124. The side surface 126 has a marginal area 128 at a top end thereof. The decorative sheet 30 has a shape corresponding to the molding recess 122 of the female mold 12. When the decorative sheet 30 is introduced into the molding recess 122 and pushed against the bottom surface 124 and the side surface 126, a height (designated “H”) of the side surface 126 is greater than a height (designated “h”) of the decorative sheet 30. Therefore, the marginal area 128 is not covered with the decorative sheet 30. A surface of the marginal area 128 is lubricious.

The male mold 14 has a core insert 142. The core insert 142 includes a main portion 144 and a locating portion 146. A diameter of the locating portion 146 is larger than a diameter of the main portion 144, thereby defining a step 148 where the locating portion 146 adjoins the main portion 144. The main portion 144 has a shape corresponding to an outer surface of the molded product. A surface of the locating portion 146 is lubricous.

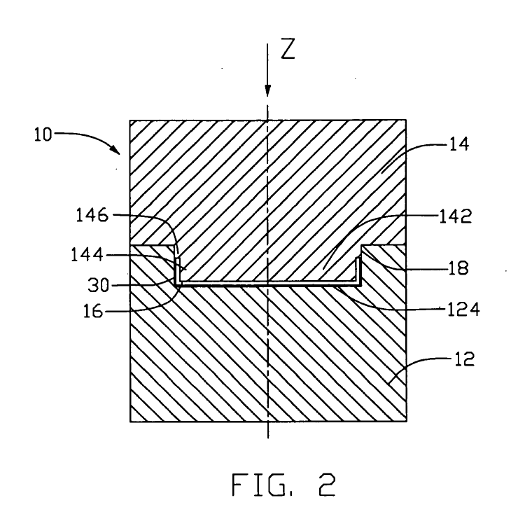

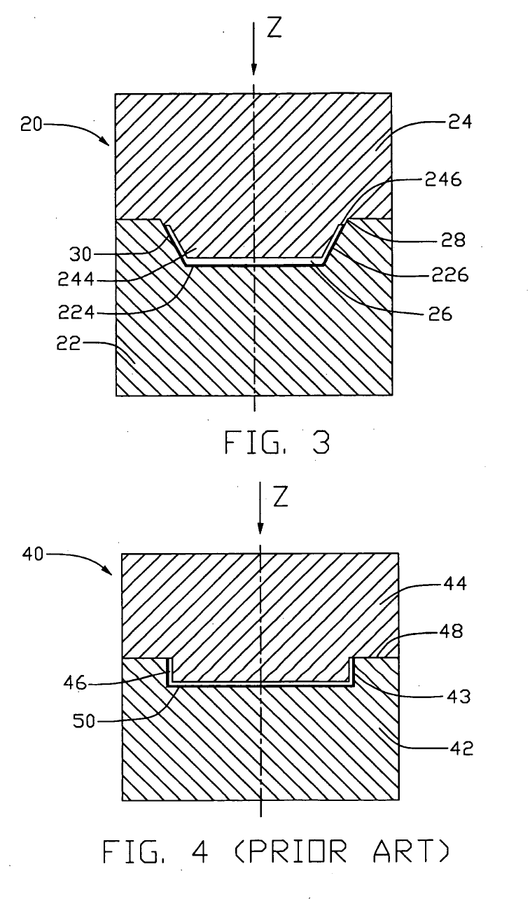

Referring also to FIG. 2, the mold 10 is closed by joining the female mold 12 and the male mold 14 together. The male mold 14 is moved toward the female mold 12 along the Z direction, and the core insert 142 is received in the molding recess 122 of the female mold 12, to thereby define a molding cavity 16. In this position, the locating portion 146 is engaged with the marginal area 128. A generally thin, flat interface area 18 parallel to the Z direction is defined between the locating portion 146 and the marginal area 128. A width of the interface area 16 is less than a thickness of the decorative sheet 30, so that the locating portion 146 abuts against a top edge of the decorative sheet 30.

A method of locating the decorative sheet 30 in the mold 10 is described as follows. Firstly, the decorative sheet 30 is placed into the molding recess 122 of the female mold 12, and pushed against the bottom surface 124 and the side surface 126 in the molding recess 122, such that the marginal area 128 is exposed above the decorative sheet 30. Secondly, the mold 10 is closed by means of gradually moving the male mold 14 toward the female mold 12, with the core insert 142 being received in the molding recess 122. Simultaneously, the locating portion 146 slidably engages with the marginal area 128 and abuts against the top edge of the decorative sheet 30. Finally, the decorative sheet 30 is positioned in its correct place by the locating portion 146 of the male mold 14. In this position, the decorative sheet 30 abuts against the bottom surface 124, the locating portion 146 is fully engaged with the marginal area 128, and the molding cavity 16 is defined between the male mold 14 and the decorative sheet 30.

FIG. 3 shows a mold 20 with a decorative sheet 30 according to a second embodiment of the present invention. The mold 20 includes a female mold 22 and a male mold 24. FIG. 3 shows that the mold 20 is closed by joining the female mold 22 and the male mold 24 together. The female mold 22 is provided with a molding recess (not labeled) in an upper portion thereof. The molding recess is surrounded by a bottom surface 224, and a peripheral side surface 226 slanted at an oblique angle relative to the bottom surface 224. The side surface 226 includes a top marginal area (not labeled). The male mold 24 has a core insert (not labeled). The core insert includes a main portion 244 and a locating portion 246. The main portion 244 has a shape corresponding to an outer surface of a product to be molded. The mold 20 shown in FIG. 3 differs from the mold 10 shown in FIGS. 1 and 2 solely in that an interface area 28 defined between the locating portion 246 and the marginal area of the side surface 226 is not parallel to the Z direction, but is oblique to the Z direction.

In summary, it can be seen that the interface area defined between the locating portion and the marginal area when the mold is closed can be parallel to the Z direction, and can be at an oblique angle relative to the Z direction.

Prior to the molding operation, the decorative sheet 30 is introduced into the molding recess and pushed against the inner surface of the female mold. As the male mold is closed onto the female mold, the decorative sheet 30 is gradually set into its correct position by way of the locating portion pushing against the top edge of the decorative sheet 30. The locating portion prevents deflection of the decorative sheet 30 out of place when the male mold is moving toward the female mold until the time when the mold 10 is in the closed position. The decorative sheet 30 is thus located in its proper position in the mold 10, so that it can be properly applied onto the surface of molded product. In particular, the decorative sheet 30 is correctly aligned with the intended location of the molded product, so that the molded product is accurately molded against the decorative sheet 30. This means that the appearance of the final molded product can be enhanced, because defects such as burring can be reduced.

It is believed that the present embodiment and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. A method for locating a decorative piece in a mold, comprising the steps of:
providing a mold, the mold comprising a female mold defining a molding recess and a male mold having a core insert, the molding recess being partly bounded by a marginal area, the core insert including a main portion and a locating portion;
placing the decorative piece in the molding recess of the female mold and pushing the decorative piece into the molding recess; and
losing the female mold and the male mold together, with the main portion being received in the molding recess, and the locating portion slidably engaging with the marginal area and pushing the decorative piece to a correct location.

2. The method according to claim 1, wherein when the locating portion is engaged with the marginal area, an interface area is defined therebetween, the interface area being at an oblique angle relative to a central axis of the mold.

3. The method according to claim 1, wherein when the locating portion is engaged with the marginal area, an interface area is defined therebetween, the interface area being parallel to a central axis of the mold.

4. The method according to claim 1, wherein the molding recess is surrounded by a bottom surface and a side surface adjoining the bottom surface, and a height of the side surface is greater than that of the decorative piece.

5. The method according to claim 1, wherein a surface of the locating portion is lubricious, and a surface of the marginal area is lubricious.

6. The method according to claim 2, wherein a thickness of the interface area is less than a corresponding thickness of the decorative piece.

7. The method according to claim 3, wherein a thickness of the interface area is less than a corresponding thickness of the decorative piece.

8. A mold for locating a decorative piece therein and manufacturing a molded product using the decorative piece, comprising:
a female mold defining a molding recess, the molding recess being partly bounded by a marginal area; and
a male mold having a core insert, the core insert including a main portion and a locating portion;
wherein when the main portion is received in the molding recess, the locating portion slidably engages with the marginal area and abuts against the decorative piece.

9. The mold as claimed in claim 8, wherein when the locating portion is engaged with the marginal area, an interface area is defined therebetween, the interface area being at an oblique angle relative to a central axis of the mold.

10. The mold as claimed in claim 8, wherein when the locating portion is engaged with the marginal area, an interface area is defined therebetween, the interface area being parallel to a central axis of the mold.

11. The mold as claimed in claim 8, wherein the molding recess is surrounded by a bottom surface and a side surface adjoining the bottom surface, and a height of the side surface is greater than that of the decorative piece.

12. The mold as claimed in claim 8, wherein a surface of the locating portion is lubricious, and a surface of the marginal area is lubricious.

13. The mold as claimed in claim 9, wherein a thickness of the interface area is less than a corresponding thickness of the decorative piece.

14. The mold as claimed in claim 10, wherein a thickness of the interface area is less than a corresponding thickness of the decorative piece.

15. The mold as claimed in claim 8, wherein a diameter of the locating portion is greater than a diameter of the main portion, thereby defining a step where the locating portion adjoins the main portion.

16. The mold as claimed in claim 15, wherein the step abuts against the decorative piece.

17. The mold as claimed in claim 8, wherein when the mold is closed by moving the male mold and the female mold together, a gap between the locating portion and the marginal area is less than a corresponding thickness of the decorative piece.

18. The mold as claimed in claim 17, wherein a diameter of the locating portion is larger than a diameter of the main portion, thereby defining a step where the locating portion adjoins the main portion so as to abut against the decorative piece.

19. A method for providing a decorative piece in a mold so as to attach said decorative piece onto a final product of said mold, comprising the steps of:
providing two separable mold portions of said mold so as to form cooperatively said final product therebetween;
attaching said decorative piece on one of said two mold portions of said mold;
positioning said decorative piece in said one of said two mold portions of said mold by means of having the other of said two mold portions of said mold reachable to said decorative piece and supportable thereto.

20. The method according to claim 19, wherein a locating portion is formed on said other of said two mold portions of said mold to reach said decorative piece and provide supportive force for positioning thereof.
